(19) United States
(12) Patent Application Publication
(10) Pub. No.: US 2010/0248066 A1
(43) Pub. Date: Sep. 30, 2010

(54) Modified Fuel Cell Manifolds for Controlling Fuel Gas Flow to Different Sections of Fuel Cell Stacks

(76) Inventors: Henning Frederiksen, Svendborg (DK); Jorgen Schjerning Lundsgaard, Svendborg (DK)

Correspondence Address: LICATA & TYRRELL P.C., 66 E. MAIN STREET, MARLTON, NJ, 08053, US

(21) Appl. No.: 12/521,992

(22) PCT Filed: Jan. 4, 2008
(86) PCT No.: PCT/EP08/50068

§ 371 Date: May 21, 2010

Related U.S. Application Data
(60) Provisional application No. 60/878,511, filed on Jan. 4, 2007.

(51) Int. Cl. H01M 8/24; H01M 8/04

(52) U.S. Cl. 429/458; 429/513

(57) ABSTRACT

A fuel delivery manifold enlarged in size is provided which, when incorporated into fuel cells which are then stacked allows for insertion of a baffle or a perforated fuel delivery tube through the fuel cell stack via the enlarged fuel delivery manifold to enhance and/or even out or equalize fuel delivery to all fuel cells in the fuel cell stack.

This patent application claim priority to U.S. Provisional Application Ser. No. 60/878,511, filed Jan. 4, 2007, teachings of which are herein incorporated by reference in their entirety.

### FIELD OF THE INVENTION

The present invention relates to a fuel cell with a fuel delivery manifold modified in size so that, when stacked, a baffle or a perforated fuel delivery tube can be inserted through the fuel cell stack via the modified manifold to enhance and/or even out or equalize fuel delivery to all fuel cells in the fuel cell stack.

### BACKGROUND OF THE INVENTION

A conventional hydrogen Polymer Electrolyte Membrane (PEM) fuel cell configuration is depicted herein in FIG. 1. In this conventional configuration, the required number of single cells is stacked and the gas supply to each single cell is connected in parallel. Fuel and air required for the electrochemical reaction are fed at the appropriate rate via common manifolds. The direction of the gas flow is arbitrary and is shown as falling arrows in FIG. 1. Fuel gas supply to each of the individual cells from the manifold at the top of the stack is essentially equal. Similarly, the exhaust gas is collected and removed from the stack via the outlet manifold at the bottom of the stack. Thus, in the conventional fuel cell configuration shown in FIG. 1, the supply gas flow follows in parallel flow paths in identical flow directions and hypothetically at uniform flow rates through each of the individual cells.

In some cases, particularly where hydrogen produced by electrolysis is not feasible or not available in sufficient quantity or at a reasonable cost, fuel for electrochemical fuel cells is obtained from carbon available as organic refuse or other sources such as low grade petroleum deposits including, but not limited to oil-shale, oil sand, gilsonite and coal. Both fossil fuels, such as natural gas, petrol or heating oil and biogenic/regenerative fuels, such as wood, alcohol or rapeseed oil, can be used in this process. Methods for producing a CO/H2 mixture from organic material, petroleum coke or from coal deposits for use as a source of hydrogen for direct electrochemical conversion in fuel cells are also available. The alternative fuels are referred to as reformer fuels.

However, in cases where 100% of the hydrogen gas supply is replaced by reformer gas containing, for example, 75% hydrogen and 25% of either nitrogen or carbon dioxide, it has been observed that individual cells in the stacked sequence fail unpredictably after a certain time. It is not possible to predict the operational time period before cell performance deteriorates, nor is it possible to predict which cell and how many cells will fail. It is possible to revive the affected cells in a stack by either switching to pure hydrogen gas supply for a short time period, or by increasing the gas flow rate by a factor of 2.5-3 (depending on the number of cells in the stack) for a limited period of time.

While single cells perform well and predictably under these conditions, when stacked, one or more cells can become locally depleted of fuel gas on the anode side. As a consequence, these cells suddenly operate at a fuel stoichiometry of λ<1 thus resulting in cell voltage decreases and, in some cases, a reversal of the electrochemical process occurring in the cell. Such an event can lead to permanent damage of the fuel cell stack.

The problem appears to be related to uneven fuel supply on the anode side to certain cells in the fuel cell stack.

In particular the problem appears to affect the downstream cells fed from the common fuel feed manifold. It is symptomatic that the final cell and its immediate neighbors are prone to fail; the failure pattern being that one of the ultimate cells of the stack fails to maintain flow on the anode side and the cells floods due to the accumulation of water. Subsequently the proximal cells also seriously suffer from a drop in output and fail.

An anode stoichiometry λ close to 2.8 is required to ensure that a stack of 70 cells operates. A lesser λ value in the range 1.5 to 2 suffices for a smaller stack of 25 cells. This stoichiometric excess is used in an attempt to keep the last cell in the stack performing in spite of the tendency for these cells to lose efficiency and drop out. However, a considerable amount of excess fuel must be made available. This is wasteful and undesirable.

Accordingly there is a need to provide better means for ensuring optimal fuel flow into all fuel cells of a fuel cell stack connected to the common supply manifold.

### SUMMARY OF THE INVENTION

The present invention provides means for optimizing fuel delivery to all fuels cells of a fuel cell stack. In the present invention, the size of the fuel delivery manifold has been enlarged as compared to the fuel delivery manifold of standard fuel cells.

In one embodiment, a baffle is inserted into the fuel delivery manifold which extends through the stacked fuel cells from the first fuel cell of the stack to the fuel cell adjacent to the last fuel cell of the stack thereby evening out fuel delivered to the first and last fuel cells of the fuel cell stacks and cells adjacent thereto.

In another embodiment, a perforated pipe is inserted into the fuel delivery manifold which extends through the stacked fuels cells from the first fuel cell of the stack to the last fuel cell of the stack. The perforated pipe serves as a supply channel for the fuel to each fuel delivery manifold. In this embodiment, the pipe is preferably perforated radially in a stepped pattern so that when it is put under tension the pipe deforms elastically so as to provide a regulated flow path for fuel to pass from the perforated pipe into all sections of the manifold. Also preferred is that the pipe extend beyond the first fuel cell and the last fuel cell of the stack so that it can act as a fixing means in place of the bolts typically used to fix the stack and to provide compression of gaskets and sealing features so that all channels are tightly sealed against fluid loss. In this embodiment of the present invention, each manifold of the fuel cell is enlarged so that perforated pipes can extend through each of the delivery and exit manifolds, thus serving as both supply channels for fuel and air or exhaust channels for reaction products, spent fuel and spent air, as well as the fixing and compression means of the fuel cell stack.

### BRIEF DESCRIPTION OF THE FIGURES

FIG. 1 is a diagram depicting a conventional fuel cell stack gas flow configuration.

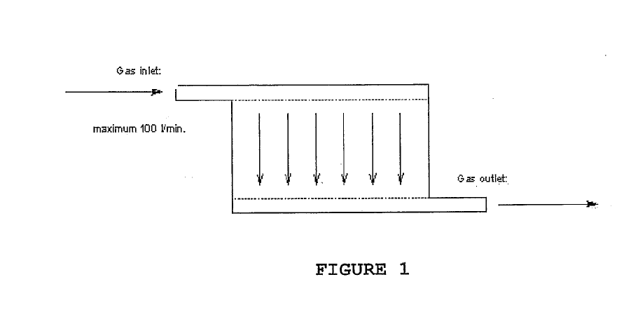

FIGS. 2A and 2B are diagrams of a fuel cell of the present invention wherein the fuel delivery manifold is enlarged as compared to that of a conventional fuel cell so that a longitudinal baffle can be inserted through a fuel cell stack via the fuel delivery manifolds. FIG. 2A provides a diagram of the enlarged fuel delivery manifold while FIG. 2B shows the fuel cell with the enlarged fuel delivery manifold in position.

FIGS. 3A and 3B are diagrams of one embodiment of a baffle perforated along its length to allow for fuel flow to cells of the fuel cell stack in need thereof. FIG. 3A provides a view of baffle in the manifold while FIG. 3B shows the baffle extending through the manifolds of multiple cells of the fuel cell stack.

FIG. 4A through 4C are diagrams of an embodiment of a fuel cell and fuel cell stack of the present invention wherein the fuel delivery manifold is enlarged and a perforated pipe is extended through the fuel cell stack via each enlarged fuel delivery manifold. FIG. 4A is a diagram of a single fuel cell with pipes extending through each enlarged manifold. FIG. 4B is a diagram of fuel cell stack containing 70 single fuel cells stacked adjacently, each fuel cell having enlarged fuel and air delivery and exit manifolds and perforated pipes extending through the manifolds which supply and exhaust gases to and from the manifold and which serve as a fixing and compression means for the fuel cell stack. FIG. 4C is a diagram of an exemplary perforated pipe useful in this embodiment with the nut and washer which fit onto the ends of each pipe for fixing and compression of the fuel cell of the fuel cell stacks.

### DETAILED DESCRIPTION OF THE INVENTION

The present invention provides for design of a modified fuel delivery manifold for use in fuel cells and stacks thereof to provide for careful control of the fuel gas flow in different sections of the fuel cell stack.

In the fuel cells of the present invention, the fuel delivery manifold is enlarged as compared to the fuel delivery manifold of conventional fuel cells. In a preferred embodiment, the fuel delivery manifold is at least twice the height of a conventional manifold. A typical size for a conventional manifold is 40 mm in width by 15 mm in height. Thus, an exemplary size for the modified fuel delivery manifold of the present invention is 40 mm in width by 30 mm in height. In some embodiments of the present invention, similar size modifications are made to the fuel exit and air delivery and exit manifolds as well.

The size modification of the fuel delivery manifold of the present invention is made to incorporate a means into the fuel cell delivery manifold which enhances and/or evens out fuel delivery to all fuel cells in a fuel cell stack.

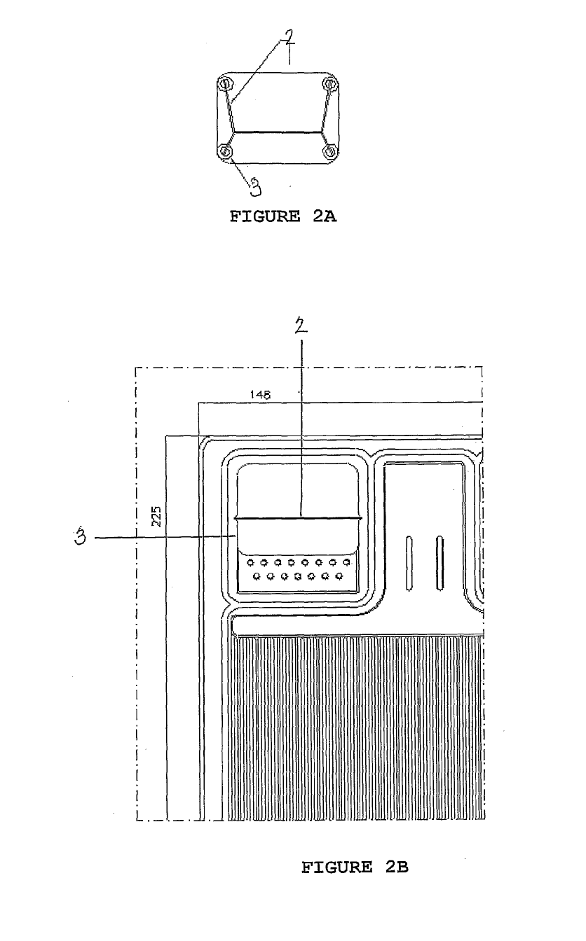

In one embodiment of the present invention, as depicted in FIGS. 2A and 2B, this means comprises a baffle 2 which is inserted into the enlarged fuel delivery manifold 3 and extends from the first fuel cell of a fuel cell stack to the fuel cell adjacent to the last fuel cell of the fuel cell stack. As shown in FIGS. 2A and 2B, this baffle extends horizontally across the enlarged fuel delivery manifold from one side of the manifold to the other essentially splitting the fuel delivery manifold into a top and bottom section. In one embodiment, the baffle provides for separation of the manifold into a top section and a bottom section. In this embodiment, fuel supplied to the fuel delivery manifold of the first fuel cell in the fuel cell stack thus feeds into both the top section and the bottom section. Fuel in the bottom section flows into the first fuel cell and cells adjacent thereto. Fuel in the top section flows through all the fuel delivery manifolds of the fuel cell stack to the last fuel cell of the stack at which point the baffle no longer extends. At this point fuel flows to the last fuel cell of the stack and fuel cells adjacent thereto. Thus in this embodiment, equal amounts of fuel are supplied to both the first fuel cell and last fuel cell of the stack thereby evening out fuel delivery to all fuel cells in a fuel cell stack.

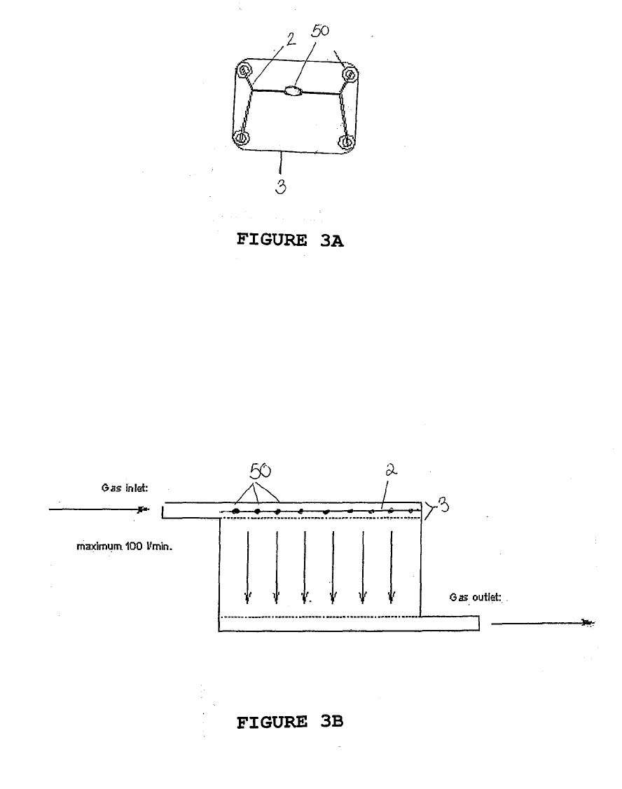

In another embodiment, as depicted in FIGS. 3A and 3B, the baffle 2 comprises a plurality of perforations 50 which allow for flow of fuel from the top section to the bottom section of the manifold 3 when required to provide additional fuel to any cells of the stack in need thereof. In this embodiment, it has been demonstrated that fuel from the top section of the manifold will be sucked through the perforations of the baffle into the bottom section of the manifold to provide fuel to, for example, center fuel cells of the stack in need thereof.

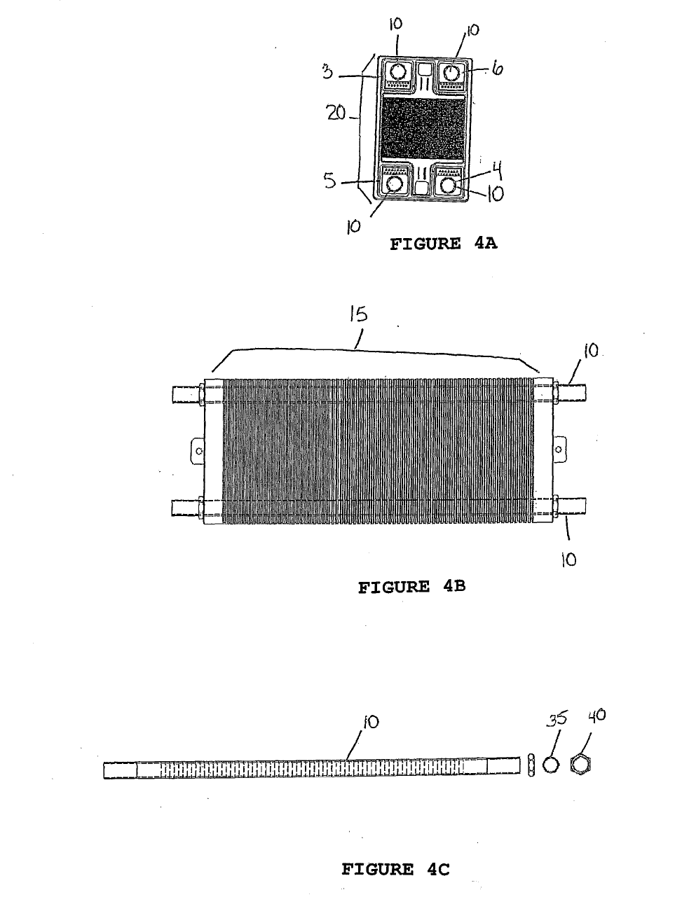

In yet another embodiment of the present invention, as depicted in FIGS. 4A through 4C, this means comprises a perforated pipe 10 which extends through the fuel cell stack 15 from the first fuel cell 20 of the stack to the last fuel cell 25 of the stack. The perforated pipe serves as a supply channel for the fuel to each fuel delivery manifold and each fuel cell of the stack. In one embodiment, the pipe is perforated radially in a stepped pattern so that when the pipe is put under tension the pipe deforms elastically so as to provide a regulated flow path for fuel to pass from the perforated pipe into each enlarged fuel delivery manifold to each fuel cell of the stack. In another embodiment, the radial slits in the tube are formed so that the tube accommodates thermal expansion in the stack. In this embodiment, regardless of the altitude of the stack the water produced will drain through the apertures in the tubes and thus be exhausted.

Various perforation patterns can be used in the tubes. Preferred is a pattern wherein the sum of the slit apertures is comparable with the tube cross sectional area. Also preferred is a perforation pattern wherein the oxidizer tubes on the cathode side have bigger apertures. An exemplary perforation pattern is 6 slits of 7 mm length per circumference in a 25 mm diameter and 0.2 mm thick seamless 316L alloy tube. Alternative alloys such as a ferritic stainless alloy in a seamless tube or Etronax G tubes available from Electro-Isola a/s, Gronlandsvej 197. DK-7100 Vejle.Vejle can also be used.

In this embodiment, it is preferred that other manifolds of each fuel cell, such as the fuel exit manifold 4, the air delivery manifold 5 and the air exit manifold 6 also be enlarged in accordance with the design described herein so that perforated pipes for exhausting fuel and supplying and exhausting air cells can also be inserted into these manifolds, respectively. In embodiments wherein pipes are inserted into each of these manifolds, it is preferred that the pipes extend beyond the first fuel cell and the last fuel cell of the stack so that the pipes can act as a fixing means in place of the bolts which are typically used. Like bolts, these pipes extending from the first fuel cell and last fuel cell of the stack can be used to fix the stack and to provide compression of gaskets and sealing features so that all channels are tightly sealed against fluid loss. In one embodiment, as depicted in FIG. 3C, the outer surface of the extended ends of the pipe are threaded so that a washer 35 and nut 40 can be fitted around the pipe and tightened to fix and compress the stack of fuel cells. In a preferred embodiment the bolt tension is approximately 2500N per bolt or threaded pipe. In a preferred embodiment a M25x1 helical thread terminates the pipe. (M=metric 25 mm thread with 1 mm pitch.)

As will be understood by those skilled in the art upon reading this disclosure, while the present invention has been illustrated by the exemplary embodiments depicted in FIG. 2-4, it is foreseen that other designs based on teachings herein are possible.

What is claimed is:

1. A fuel cell comprising a fuel delivery manifold enlarged to about two times the height of a fuel delivery manifold of a standard fuel cell.

2. The fuel cell of claim 1 further comprising a fuel exit manifold, an air delivery manifold and an air exit manifold, wherein each manifold is enlarged to about two times the height of a fuel delivery manifold of a standard fuel cell.

3. A fuel cell stack comprising a plurality of fuel cells of claim 1 with enlarged fuel delivery manifolds and a baffle extending from a first fuel cell in the fuel cell stack to a fuel cell adjacent to a last fuel cell in the fuel cell stack via the enlarged fuel delivery manifold, said baffle dividing the fuel delivery manifold into a top section and a bottom section.

4. The fuel cell stack of claim 3 wherein the baffle is perforated.

5. A fuel cell stack comprising a plurality of fuel cells of claim 1 with enlarged fuel delivery manifolds and a perforated pipe extending from a first fuel cell in the fuel cell stack to a last fuel cell in the fuel cell stack via the enlarged fuel delivery manifolds, said perforated pipe supplying fuel to the fuel delivery manifolds of each fuel cell.

6. A fuel cell stack comprising a plurality of fuel cells of claim 2 with enlarged fuel delivery manifolds, fuel exit manifolds, air delivery manifolds and air exit manifolds and four perforated pipes, each pipe extending from a first fuel cell in the fuel cell stack to a last fuel cell in the fuel cell stack via the enlarged fuel delivery manifolds, fuel exit manifolds, air delivery manifolds and air exit manifolds, said perforated pipes supplying or exhausting fuel or air from their respective manifolds.

7. The fuel cell stack of claim 6 wherein the perforated pipes extend out from the first fuel cell and last fuel cell of the stack and provide a means for fixing and compressing the fuel cell stack.
